(19) United States
(12) Patent Application Publication
(10) Pub. No.: US 2009/0091549 A1
(43) Pub. Date: Apr. 9, 2009

(54) TOUCH PANEL AND INPUT DEVICE USING THE SAME

(76) Inventors: Kenichi Matsumoto, Osaka (JP); Koji Tanabe, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/245,953

(22) Filed: Oct. 6, 2008

(30) Foreign Application Priority Data
Oct. 9, 2007 (JP) 2007-263089

(51) Int. Cl. G06F 3/041; B32B 7/00

(52) U.S. Cl. 345/173; 428/105

(57) ABSTRACT

A touch panel includes multiple belt-like upper conductive layers and lower conductive layers formed in an orthogonal direction to the upper conductive layers. Those two kinds of layers are formed on a light transmissible substrate. A strong adhesion layer and a weak adhesion layer are layered together on a top face or an underside of the light transmissible substrate. The presence of the weak adhesion layer allows peeling off the touch panel from a cover of an apparatus fairly easier when the touch panel needs to be retrofitted to the cover. Since the weak adhesion layer is peeled off together with the strong adhesion layer, it will not be transferred or attached onto the cover. No time or labor is thus needed for removing the layer transferred or attached to the cover. The touch panel capable of being retrofitted with ease is thus obtainable.

### FIELD OF THE INVENTION

The present invention relates to a touch panel to be used for operating a variety of electronic apparatuses, and an input device using the same touch panel.

### BACKGROUND OF THE INVENTION

In recent years, a variety of electronic apparatuses, including cell phones and car navigation systems, have been downsized and sophisticated. This market trend has increased the use of touch panel mounted to various apparatuses for switching the functions of those apparatuses. For instance an optically transparent and electrostatic touch panel is mounted on the front of display element such as a liquid crystal display device. Through this touch panel, letters, symbols, or patterns displayed on the display element behind the touch panel can be selected with a finger or a dedicated pen, thereby switching the functions. A touch panel excellent in visible recognition and workability among others is required from the market.

A conventional touch panel and an input device using the same conventional touch panel are described hereinafter with reference to FIGS. 4 and 5. The dimensions along a thickness direction in the drawings are enlarged for easier understanding of the structure.

FIG. 4 shows a sectional view of the conventional touch panel. In FIG. 4, multiple upper conductive layers 3 are formed on the top face of film-like upper substrate 1 of light transmission, and multiple lower conductive layers 4 are also formed on the top face of film-like lower substrate 2 of light transmission. Each one of layers 3 and 4 is shaped like a belt and made from indium tin oxide, and is light transmissible, and layers 3 and 4 cross each other at right angles.

Upper substrate 1 is layered on the top face of lower substrate 2, and film-like light transmissible sheet 5 is layered on the top face of upper substrate 1. They are stuck to each other with adhesive (not shown), and bonding layer 6 formed on the top face of sheet 5 is stuck with releasing paper 7 at its top face, so that touch panel 8 is formed. Bonding layer 6 is made from acrylic or silicone rubber and so on.

FIG. 5 shows a sectional view of a conventional input device. In FIG. 5, housing 9 made of insulating resin is open at its top face, and transparent cover 10 made of insulating resin is rigidly mounted to the opening. Touch panel 8 with releasing paper 7 removed is bonded to the underside of cover 10 by bonding layer 6.

Display element 11 such as a liquid crystal display is placed beneath touch panel 8. Multiple upper conductive layer 3, lower conductive layers 4 and display element 11 of touch panel 8 are coupled to an electronic circuit of the input device via connectors or lead wires (not shown), so that the input device is formed.

In the input device discussed above, the top face of cover 10 is touched with a finger or a dedicated pen in response to a display on display element 11 behind touch panel 8 while the electronic circuit applies a voltage sequentially to multiple upper conductive layers 3 and lower conductive layers 4. An electrostatic capacity between upper conductive layer 3 and lower conductive layer 4 at the touched section is changed, so that the electronic circuit senses the touched section due to the change in the electrostatic capacity. Functions of the apparatus can be thus switched.

To be more specific, multiple menus are displayed on display element 11, and then the top face of cover 10 just above a given menu is touched, and the electrostatic capacity between upper conductive layer 3 and lower conductive layer 4 at the touched section is changed. The electronic circuit senses a change in the electrostatic capacity. The input device thus allows a user to select the given menu.

When the touch panel 8 discussed above is bonded to the underside of cover 10, it is sometimes bonded to a wrong place due to positional shift. When a re-bonding of touch panel 8 is tried after a peel-off of the touch panel 8, bonding layer 6 made from strong adhesion material such as acrylic is sometimes broken irregularly due to strong adhesive force. The breakage in the bonding layer will leave bonding layer 6 on the top face of touch panel 8 or on the underside of cover 10.

It is thus necessary to remove bonding layer 6 remaining on the underside of cover 10 before another touch panel 8 is bonded to cover 10. Retrofitting of touch panel 8 to cover 10 thus needs greater amounts of time and labor than expected ones.

In the case of using bonding layer 6 made from weak adhesion material such as silicone rubber, the adhesive force of layer 6 is weak, so that the entire bonding layer 6 is transferred and attached onto the top face of touch panel 8 or the underside of cover 10. Thus in the case of retrofitting touch panel 8 to cover 10, it is needed to remove bonding layer 6 left on the underside of cover 10.

Related art to the present invention is disclosed in, e.g. Unexamined Japanese Patent Application Publication No. 2005-274667.

As discussed above, the conventional touch panel and the conventional input device using the same touch panel have the following problem: When touch panel 8 is bonded to the underside of cover 10 of an apparatus, an error such as a positional shift occurs, and then touch panel 8 is removed before retrofitting it onto the underside. In such a case, it is needed to remove bonding layer 6 left on the underside of cover 10, so that the retrofitting becomes time-consuming and cumbersome work.

### SUMMARY OF THE INVENTION

The present invention addresses the foregoing problem and aims to provide a touch panel to be retrofitted with ease onto a cover of an apparatus, and also provide an input device using the same touch panel. The touch panel of the present invention has the following structure in order to achieve the foregoing objective.

The touch panel of the present invention includes the following elements:
a light transmissible substrate having a plurality of belt-shaped upper conductive layers and a plurality of belt-shaped lower conductive layers in an orthogonal direction each other; and
a strong adhesion layer and a weak adhesion layer having weaker adhesive force than that of the strong adhesion layer formed on one of a top face and an underside of the light transmissible substrate in piles.

The foregoing structure allows the presence of the weak adhesion layer to remove the touch panel with ease from the cover of the apparatus when the touch panel once bonded to the cover should be peeled off and retrofitted again to the cover. At the same time, the strong adhesion layer bonded to the weak adhesion layer is peeled off together with the weak adhesion layer, so that the cover is free from the weak adhesion layer supposed to be transferred or attached thereto. It is thus not needed to remove the bonding layer supposed to be left over when the bonding layer has been peeled off, so that retrofitting the touch panel onto the cover can be done advantageously with ease.

An input device of the present invention includes the following elements:
the touch panel discussed above;
a transparent cover having the touch panel bonded at its underside; and
a display element disposed under the touch panel.
   The foregoing structure of the input device allows retrofitting the touch panel to the cover advantageously with ease.

### BRIEF DESCRIPTION OF THE DRAWINGS

FIG. 1 shows a sectional view of a touch panel in accordance with an embodiment of the present invention.

FIG. 2 shows an exploded perspective view of the touch panel in accordance with an embodiment of the present invention.

FIG. 3 shows a sectional view of an input device in accordance with an embodiment of the present invention.

FIG. 4 shows a sectional view of a conventional touch panel.

FIG. 5 shows a sectional view of an input device using the conventional touch panel.

### DESCRIPTION OF PREFERRED EMBODIMENT

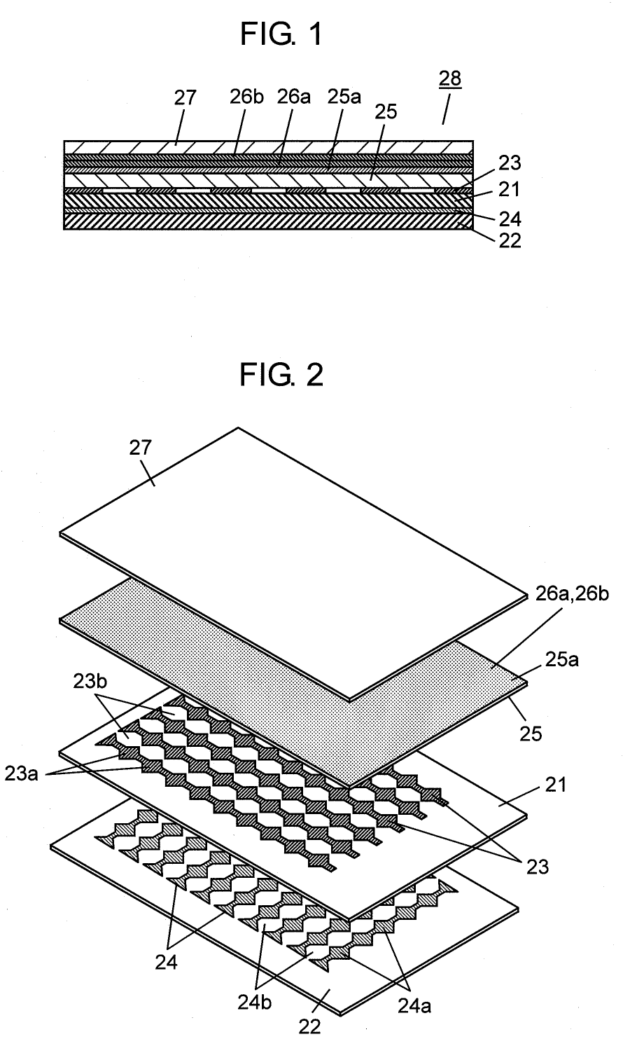

An exemplary embodiment of the present invention is demonstrated hereinafter with reference to FIG. 1-FIG. 3. For the better understanding of the structure, dimensions in the thickness direction are enlarged in the drawings. Similar elements to those in respective drawings have the same reference marks, and the descriptions thereof are sometimes omitted.

### Exemplary Embodiment

FIG. 1 shows a sectional view of a touch panel in accordance with the embodiment of the present invention. FIG. 2 shows an exploded perspective view of the touch panel. In FIG. 1 and FIG. 2, light transmissible upper substrate 21 and lower substrate 22 are made from polyether-sulfone, polycarbonate, polyethylene-terephthalate, or the like and substrates 21 and 22 are formed like film. Multiple upper conductive layers 23 shaped like a belt are formed on the top faces of upper substrates 21, and multiple lower conductive layers 24 shaped like a belt are formed on the top face of lower substrate 22. Both of layers 23 and 24 are light transmissible and made from indium tin oxide, tin oxide or the like, and layers 23 cross with layers 24 at right angles.

On multiple upper conductive layers 23 and lower conductive layers 24, multiple conductive sections 23a and 24a are formed respectively in a belt shape. Between adjacent conductive sections 23a, space 23b shaped like a square is formed. In a similar way, between adjacent conductive sections 24a, space 24b shaped like a square is formed. When upper substrate 21 is layered on lower substrate 22, multiple conductive sections 23a are layered onto spaces 24b, and multiple spaces 23b are layered onto conductive sections 24a alternately as shown in FIG. 2.

Film-like light transmissible sheet 25 includes grounding layer 25a made from indium tin oxide, tin oxide or the like on its entire top face. Upper substrate 21 is layered on the top face of lower substrate 22, and sheet 25 is layered on the top face of upper substrate 21, and they are bonded together with adhesive (not shown) such as acrylic or rubber.

On top of that, strong adhesion layer 26a and weak adhesion layer 26b having weaker adhesive force than that of the strong adhesion layer are layered one after another onto the top face of sheet 25. Strong adhesion layer 26a is, e.g. made from acrylic and its adhesive strength to glass is not smaller than 0.1N/cm and not greater than 20N/cm. Weak adhesion layer 26b is, e.g. made from olefin-based or styrene-based material and its adhesive strength to glass is not smaller than 0.01N/cm and not greater than 0.5N/cm.

Releasing sheet 27 made of paper or film is bonded onto the top face of sheet 25, to be more specific, sheet 27 covers the top face of weak adhesion layer 26b. Touch panel 28 is thus formed.

Strong adhesive layer 26a and weak adhesive layer 26b can be formed this way: First, apply strong adhesive layer 26a on the top face of sheet 25 by a screen-printing method, and then dry it. Then apply weak adhesive layer 26b onto strong adhesive layer 26a, and then dry it. This method can form layers 26a and 26b fairly easier.

In the case of using inflation method or T die method as substitute for this method, strong adhesive layer 26a and weak adhesive layer 26b also can be formed fairly easier.

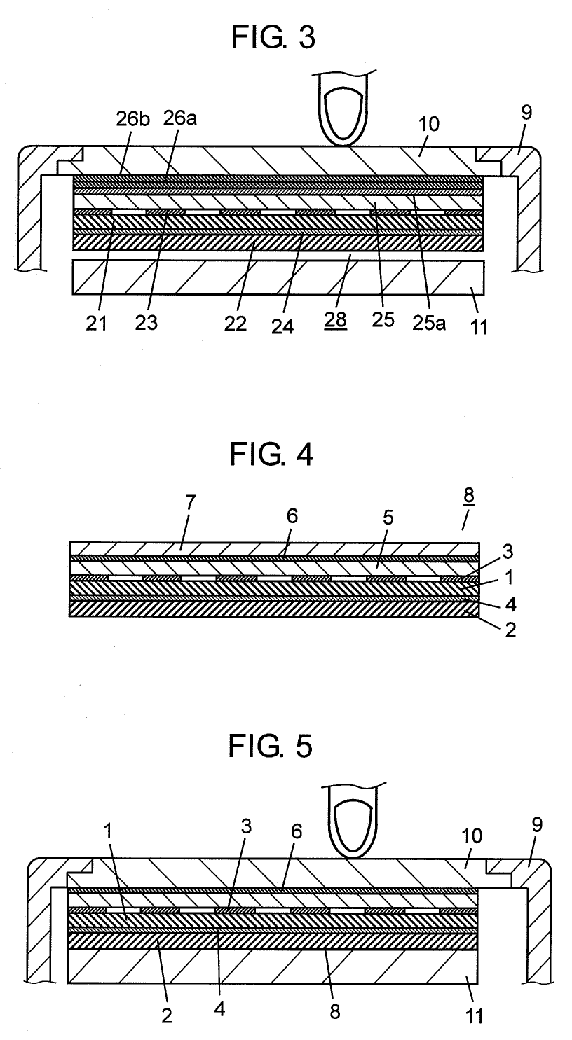

FIG. 3 shows a sectional view of an input device in accordance with an embodiment of the present invention, and this input device employs touch panel 28 discussed above. In FIG. 3, housing 9 is made from insulating resin such as polystyrene or ABS. Transparent cover 10 made from insulating resin is rigidly mounted to an opening of the top face of housing 9. Foregoing touch panel 28 with releasing paper 28 removed is bonded to the underside of cover 10 at its upper most face, i.e. weak adhesion layer 26b.

Display element 11 such as a liquid crystal display is placed under touch panel 28 with a given space, e.g. ranging from 0.5 mm to 1.0 mm. Multiple upper conductive layers 23, lower conductive layers 24, display element 11, and grounding layer 25a are connected to the electronic circuit (not shown) of the apparatus via connectors and lead wires (not shown), so that the input device is constructed.

While a voltage from the electronic circuit is applied to multiple upper conductive layers 23 and lower conductive layers 24 sequentially, the top face of cover 10 is touched with a finger or a dedicated pen in response to a display showed on display element 11 behind touch panel 28. Then the electrostatic capacity changes between upper conductive layer 23 and lower conductive layer 24 touched, so that the electronic circuit senses the place where the finger or the dedicated pen touches, and functions of the apparatus can be thus switched.

To be more specific, e.g. while multiple menus are displayed on display element 11, a finger touches at the top face of cover 10 just above a given menu showed on display element 11, then parts of electric charges stored in the finger travel to cover 10, so that the electrostatic capacity changes between upper conductive layer 23 and lower conductive layer 24 touched. The electronic circuit senses this change in electrostatic capacity, thereby selecting the given menu.

At this time, on multiple upper conductive layers 23 and lower conductive layers 24, each one of conductive sections 23a is layered on each one of spaces 24b alternately as shown in FIG. 2 and conductive sections 24a is layered on spaces 23b alternately. The change due to the finger-touch is sensed not in electrostatic capacity between upper conductive layer 23 and lower conductive layer 24, but in electrostatic capacity at the vicinity between conductive sections 23a and 24a touched by the finger. This structure thus allows the electronic circuit to sense the touched place fairly easier.

In other words, when the electronic circuit senses a change in electrostatic capacity of touch panel 28, it senses a change in the capacitance between upper conductive layer 23 and lower conductive capacity 24 in which conductive sections 23a and conductive sections 24a are formed up and down alternately. This structure allows sensing only the number of stripes summed up of multiple upper and lower conductive sections 23a and 24a, so that the place touched by the finger can be simply sensed.

When foregoing touch panel 28 is depressed, grounding layer 25a formed on sheet 25 of touch panel 28 can remove electromagnetic noise generated from touch panel 28, so that no malfunction is expected but positive input operation can be assured.

On top of that, a given space is provided between the underside of touch panel 28 and display element 11, so that noise traveling from display element 11 to touch panel 28 can be reduced. As a result, a malfunction can be prevented and more stable operation can be expected.

Touch panel 28 discussed above is bonded to the underside of cover 10 with weak adhesion layer 26b laminated together with strong adhesion layer 26a. This structure allows retrofitting touch panel 28 to cover 10 with ease even if touch panel 28 is bonded to a wrong place of cover 10 and needs to be peeled off tentatively for retrofitting.

To be more specific, when touch panel 28 is peeled off from cover 10, since touch panel 28 is bonded to cover 10 with weak adhesion layer 26b, touch panel can be removed lightly from cover 10. This weak adhesion layer 26b is layered on strong adhesion layer 26a, so that touch panel 28 is peeled off together with entire weak adhesion layer 26b which is layered on strong adhesion layer 26a, and no weak adhesion layer 26b is transferred or attached onto the top face of cover 10. It is thus not needed to remove weak adhesion layer 26b left on cover 10. As a result, a touch panel easy for retrofitting is obtainable.

This structure including a strong adhesion layer 26a and a weak adhesion layer 26b formed directly in piles allows touch panel 28 of the present invention to maintain excellent in visible recognition equal with a conventional touch panel.

Weak adhesion layer 26b is made from thermoplastic elastomer such as olefin-based or styrene-based elastomer, so that the adhesive force of layer 26b can be adjusted with ease by changing a mixed ratio of the materials. To be more specific, weak adhesion layer 26b made from a sole material, e.g. silicone rubber or urethane rubber, can be used for embodying the present invention. However, in the case of using thermoplastic elastomer, a soft segment and a hard segment are mixed therein. Here are instances:
Olefin-based elastomer is formed of ethylene-propylene and polyethylene-polypropylen.
Styrene-based elastomer is formed of poly-butadiene and polystyrene.
Urethane-based elastomer is formed of polyester-poly-ether and polyurethane.
Ester-based elastomer is formed of poly-ether-polyester and poly-ester.
Polyvinyl chloride (PVC)-based elastomer is formed of amorphous PVC and crystalline PVC.

Use of the thermoplastic elastomer as weak adhesion layer 26b allows changing the adhesive force fairly easier by varying a mixed ratio of the materials discussed above. Therefore, the adhesive force of weak adhesion layer 26b can be adjusted in response to the adhesive force of strong adhesion layer 26a for obtaining desirable peel force. This adjustment cannot be expected in the case of using a sole material such as silicone rubber or urethane rubber as weak adhesion layer 26b. The structure discussed above thus allows adjusting the adhesive force and peel force of weak adhesion layer 26b with ease.

In the foregoing discussion, upper conductive layer 23 is formed on the top face of upper substrate 21, and lower conductive layer 24 is formed on the top face of lower substrate 22, and layer 23 crosses with layer 24 at right angles. On top of that, grounding layer 25a is formed on the top face of sheet 25. These layers are layered together for forming touch panel 28. However, lower conductive layer 24, upper conductive layer 23, and grounding layer 25a are layered together on the top face of one single substrate. This structure also can be applicable to the present invention.

To be more specific, multiple lower conductive layers 24 are formed on the top face of a single substrate through printing, then layers 24 are covered with an insulating layer made from polyester or epoxy. Upper conductive layers 23 are layered on this cover along the orthogonal direction to layers 24. Then an insulating layer and grounding layer 25a are formed sequentially on layers 23 for completing a touch panel. This structure needs a smaller number of structural components than touch panel 28 discussed previously, so that a less expensive touch panel can be formed.

In the description of touch panel 28, a given space is provided between the underside of touch panel 28 and display element 11. However, a strong adhesion layer and a weak adhesion layer can be provided also to the underside of touch panel 28 so that touch panel 28 can be bonded to display element 11 with these adhesion layers. Although this structure rather weakens the advantage of noise reduction, it can be applicable to the present invention.

As discussed previously, the embodiment proves that multiple belt-like upper conductive layers 23 and lower conductive layers 24 are formed in an orthogonal direction to each other on a light transmissible substrate, and strong adhesion layer 26a is layered together with weak adhesion layer 26b having weaker adhesive force than that of the strong adhesion layer on the top face or the underside of the light-transmissible substrate, so that touch panel 28 is formed. This structure allows retrofitting touch panel 28, which has been once bonded to cover 10 of an apparatus but peeled off tentatively, to cover 10 again with ease, because the peel-off can be done fairly easier due to the presence of weak adhesion layer 26b. Touch panel 28 can be peeled off due to the presence of weak adhesion layer 26b being bonded to strong adhesion layer 26a, so that no weak adhesion layer 26b remains, e.g. being transferred or attached, on cover 10. Thus no time or labor for removing layer 26b from cover 10 is needed. It can be thus concluded that the touch panel of the present invention can be retrofitted fairly easier onto the cover of apparatuses, and input devices employing the same touch panel are thus obtainable.

Use of weak adhesion layer 26b made from thermoplastic elastomer allows adjusting the adhesive force of layer 26b fairly easier by varying a mixed ratio of the materials than the case of using weak adhesion layer made from a sole material such as silicone rubber or urethane rubber.

A touch panel or an input device of the present invention allows advantageously retrofitting themselves onto a cover of an apparatus with ease, so that they are useful for operating a variety of electronic apparatuses.

What is claimed is:

1. A touch panel comprising:
a light transmissible substrate having a plurality of belt-shaped upper conductive layers and a plurality of belt-shaped lower conductive layers in an orthogonal direction each other; and
a strong adhesion layer and a weak adhesion layer having weaker adhesive force than that of the strong adhesion layer formed on one of a top face and an underside of the light transmissible substrate in piles.

2. The touch panel of claim 1, wherein the weak adhesion layer is made from thermoplastic elastomer.

3. An input device comprising:
a touch panel including:
a light transmissible substrate having a plurality of belt-shaped upper conductive layers and a plurality of belt-shaped lower conductive layers in an orthogonal direction each other;
a strong adhesion layer and a weak adhesion layer having weaker adhesive force than that of the strong adhesion layer formed on one of a top face and an underside of the light transmissible substrate in piles;
a light transmissible cover including the touch panel bonded to an underside of the light transmissible cover; and
a display element disposed under the touch panel.

4. The input device of claim 3, wherein the weak adhesion layer is made from thermoplastic elastomer.
